(19) United States
(12) Patent Application Publication
(10) Pub. No.: US 2024/0305944 A1
(43) Pub. Date: Sep. 12, 2024

(54) FIRST-PERSON AUDIO-VISUAL OBJECT LOCALIZATION SYSTEMS AND METHODS

(71) Applicant: University of Rochester, Rochester, NY (US)

(72) Inventors: Chenliang Xu, Pittsford, NY (US); Chao Huang, Rochester, NY (US); Yapeng Tian, Plano, TX (US); FNU Anurag Kumar, Bothell, WA (US)

(21) Appl. No.: 18/599,398

(22) Filed: Mar. 8, 2024

Related U.S. Application Data
(60) Provisional application No. 63/451,272, filed on Mar. 10, 2023.

(51) Int. Cl. H04S 7/00; G06T 7/33; G06T 7/73; G06T 19/00

(52) U.S. Cl. CPC H04S 7/302; G06T 7/337; G06T 7/74; G06T 19/00; G06T 2207/10016; G06T 2207/20081; G06T 2207/20084; H04S 2400/11

(57) ABSTRACT

A localization system may include an image input that receives images from a video source and an audio input that receives, from the video source, audio synchronized with the images. The localization system may also include an audio feature disentanglement network that correlates distinct audio elements from the audio input with corresponding visual features from the image input. Additionally, the localization system may include a geometry-based feature aggregation module that estimates a geometric transformation between two or more images from the video source and aggregates the visual features. Various other devices, systems, and methods are also disclosed.

This application claims the benefit of U.S. Provisional Application No. 63/451,272, filed Mar. 10, 2023, the disclosure of which is incorporated, in its entirety, by this reference.

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 illustrates sounding object localization in egocentric videos, in accordance with various embodiments.

FIG. 2 shows an example overview of an egocentric audio-visual object localization framework, in accordance with various embodiments.

FIG. 3 shows an example overview of a geometry-aware modeling approach, in accordance with various embodiments.

FIG. 4 shows an example temporal context aggregation process, in accordance with various embodiments.

FIG. 5 shows examples of Epic Sounding Object dataset and its statistics, in accordance with various embodiments.

FIG. 6 illustrates a qualitative comparison of different methods on the Epic Sounding Object dataset, in accordance with various embodiments.

FIG. 7 illustrates localization results on exemplary scenarios, in accordance with various embodiments.

FIG. 8 is a block diagram of an exemplary system for localizing objects that emit sounds in images in egocentric videos, in accordance with embodiments of this disclosure.

FIG. 9 is an illustration of exemplary augmented-reality glasses that may be used in connection with embodiments of this disclosure.

FIG. 10 is an illustration of an exemplary virtual-reality headset that may be used in connection with embodiments of this disclosure.

### DETAILED DESCRIPTION OF EXAMPLE EMBODIMENTS

Humans naturally perceive surrounding scenes by unifying sound and sight in a first-person view. Likewise, machines are advanced to approach human intelligence by learning with multisensory inputs from an egocentric perspective. As challenging egocentric audio-visual object localization tasks are explored herein, it may be observed that 1) egomotion commonly exists in first-person recordings, even within a short period, and 2) out-of-view sound components can be created while wearers shift their attention away. To address the first problem, a geometry aware temporal context aggregation module is proposed to handle egomotion explicitly. The effect of egomotion may be mitigated by estimating the temporal geometry transformation and exploiting it to update visual representations. Moreover, a cascaded feature enhancement module is proposed to tackle the second problem. Such a module may improve cross-modal localization robustness by disentangling visually-indicated audio representation. During training, naturally available audio-visual temporal synchronization may be utilized as the “free” self-supervision to avoid costly labeling. An “Epic Sounding Object” dataset has also been created and annotated for evaluation purposes. Extensive experiments show that the disclosed method may achieve state-of-the-art localization performance in egocentric videos and can be generalized to diverse audio-visual scenes.

The emergence of wearable devices has drawn the attention of the research community to egocentric videos, the significance of which can be seen from egocentric research in a variety of applications such as robotics, virtual reality, augmented reality, and healthcare. In recent years, the computer vision community has made substantial efforts to build benchmarks, establish new tasks, and develop frameworks for egocentric video understanding.

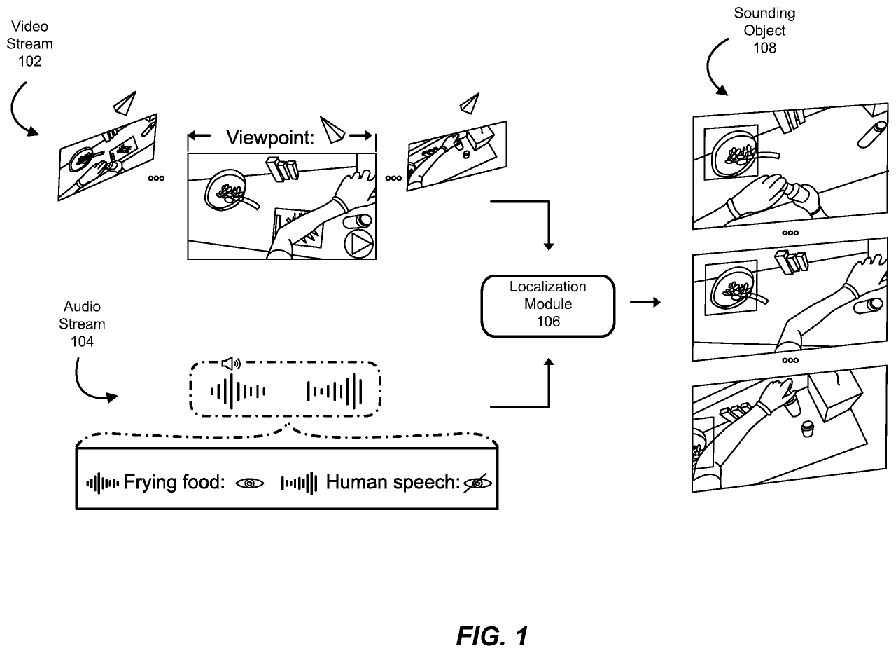

While existing works achieve promising results in the egocentric domain, it remains an interesting but challenging topic to perform fine-grained egocentric video understanding. For instance, understanding which object is emitting sound in a first-person recording is difficult for machines. As shown in FIG. 1, in video stream 102, the wearer moves his/her head to put down the bottle. The frying pot which emits sound captured in audio stream 104 subsequently suffers deformation and occlusion due to the wearer's egomotion. Human speech outside the wearer's view also affects the machine's understanding of the current scene. As described in greater detail below, the systems described herein may include a localization module 106 that receives video stream 102 and audio stream 104 as input and produces a sounding object 108.

The example illustrated in FIG. 1 reveals two significant challenges for designing powerful and robust egocentric video understanding systems: First, people with wearable devices usually record videos in naturalistic surroundings, where a variety of illumination conditions, object appearance, and motion patterns are shown. The dynamic visual variations introduce difficulties in achieving accurate visual perception. Second, egocentric scenes are often perceived within a limited field of view (FoV). The common body and head movements of users cause frequent view changes, which brings object deformation and creates dynamic out-of-view content.

While a visual-only system struggles to fully decode the surrounding information and perceive scenes in egocentric videos, audio provides stable and persistent signals associated with the depicted events. Instead of purely visual perception, numerous psychological and cognitive studies show that integration of auditory and visual signals is significant in human perception. Audio, acting as an essential but less focused modality, often provides synchronized and complementary information with the video stream. In contrast to the variability of first-person visual footage, sound describes the underlying scenes consistently. These natural characteristics make audio another indispensable ingredient for egocentric video understanding.

To effectively leverage audio and visual information in egocentric videos, a pivotal problem is to analyze the fine-grained audio-visual association, i.e., discovering what objects are emitting sounds in the scene. The systems described herein may perform a novel egocentric audio-visual object localization task that associates audio with dynamic visual scenes and localize sounding objects in egocentric videos. Due to the dynamic nature of egocentric videos, it is extremely challenging to associate visual content from different viewpoints with audio captured from the entire space. Hence, a new framework explicitly models the distinct characteristics of egocentric videos by integrating audio. In the framework, a geometry-aware temporal modeling module is proposed to handle egomotion explicitly. The egomotion in egocentric videos may lead to large motions and object deformations, making it difficult to consistently localize the sounding objects. The disclosed approach mitigates the effect of egomotion by performing geometric transformations in the embedding space and aligning visual features of different frames. Based on the aligned features, temporal contexts across frames are further leveraged to learn discriminative cues for localization. In addition, a cascaded feature enhancement module is proposed to handle out-of-view sounds. This module may help mitigate audio noises and improves cross-modal localization robustness.

Due to the dynamic nature of egocentric videos, it is hard and costly to label sounding objects for supervised training. To avoid tedious labeling, this task has been formulated in a self-supervised manner and the disclosed framework has been trained with self-supervision from audio-visual temporal synchronization. Since there are no publicly available egocentric sounding object localization datasets, an Epic Sounding Object dataset has been annotated to facilitate research in this field. Experimental results demonstrate that modeling egomotion and mitigating out-of-view sound can improve egocentric audio-visual localization performance.

Contributions of the system described herein may include: (1) the first systematical study on egocentric audio-visual sounding object localization; (2) an effective geometry-aware temporal aggregation approach to deal with unique egomotion in first-person videos; (3) a novel cascaded feature enhancement module to progressively inject the audio and visual features with localization cues; and (4) an Epic Sounding Object dataset with sounding object annotations to benchmark the localization performance in egocentric videos.

Taking the natural audio-visual synchronization in videos, a large number of studies in the past few years have proposed to jointly learn from both auditory and visual modalities. A spectrum of new audio-visual problems and applications have been seen, including visually guided sound source separation, audio-visual event localization, and sounding object visual localization. Most previous approaches learn audio-visual correlations from third-person videos, while the distinct challenges of audio-visual learning in egocentric videos are underexplored. Different from existing works, an audio-visual learning framework is proposed to explicitly solve egomotion and out-of-view audio issues in egocentric videos.

In the last decade, video scene understanding techniques thrived because of the well-defined third-person video datasets. Nevertheless, most of the algorithms are developed to tackle videos curated by human photographers. The natural characteristics of egocentric video data, e.g., view changes, large motions, and visual deformation, are not well-explored. To bridge this gap, multiple egocentric datasets have been collected. These datasets have significantly advanced investigations on egocentric video understanding problems, including activity recognition, human(hand)-object interaction, anticipation, and human body pose inferring. However, only a handful of audio-visual works have been presented for egocentric video understanding. There are limited studies in explicit egomotion mitigation and fine-grained audio-visual association learning in egocentric videos. Unlike past works, the present disclosure addresses challenges in egocentric audio-visual data and proposes a robust sounding object localization framework. To enable the research, a dataset based on Epic-Kitchens has been used. The disclosed model attempts to discover the fine-grained audio-visual association in egocentric videos and therefore understand the surrounding scenes from the first-person view.

Given an egocentric video clip V={Iᵢ}ᵢ₌₁^{T} in T frames and its corresponding sound stream s, audio-visual sounding object localization aims at predicting location maps O={Oᵢ}ᵢ₌₁^{T} that represent sounding objects in the egocentric video. Specifically, Oᵢ(x,y)∈{0,1} and positive visual regions indicate locations of sounding objects. In real-world scenarios, the captured sound can be a mixture of multiple sound sources s=Σₙ₌₁^{N}sₙ where sₙ is the n-th sound source and it could be out of view. For the visual input, the video frames may be captured from different viewpoints. To design a robust and effective egocentric audio-visual sounding object localization system, the above issues in egocentric audio and visual data may be considered and two key questions may be addressed: (Q1) how to associate visual content with audio representations while out-of-view sounds may exist; (Q2) how to persistently associate audio features with visual content that are captured under different viewpoints.

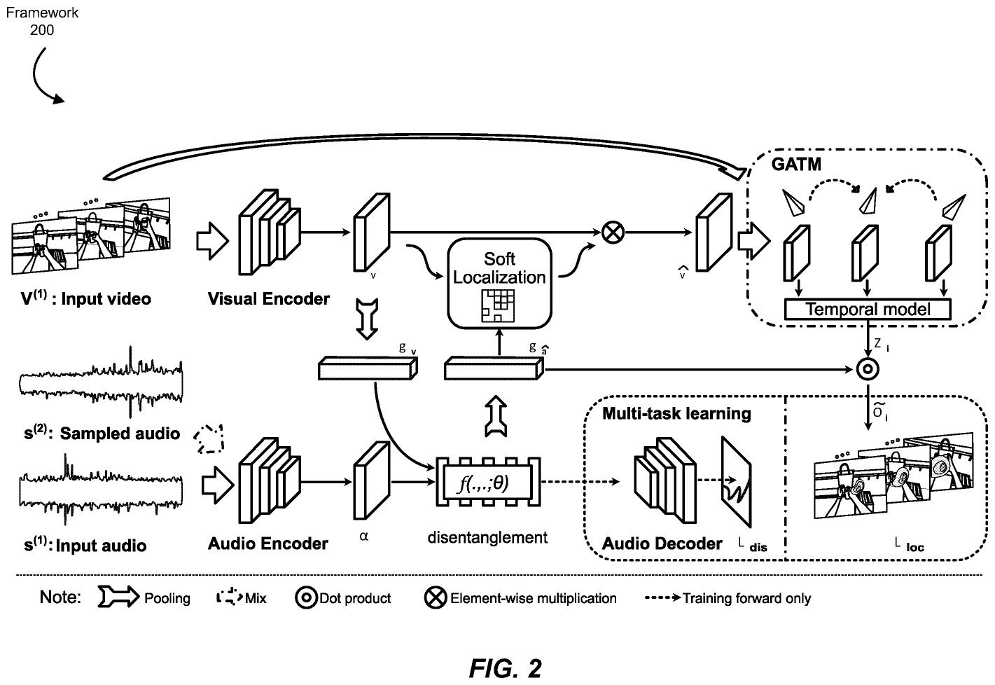

Due to the dynamic nature of egocentric videos, it is difficult and costly to annotate sounding objects for supervised training. To bypass the tedious labeling, the egocentric audio-visual object localization task may be solved in a self-supervised manner. The proposed framework is illustrated as framework 200 in FIG. 2. The model first extracts representations from the audio s and video clip V. In order to handle Q1, a cascaded feature enhancement module has been developed to disentangle visually indicated sound sources and attend to visual regions that correspond to the visible sound sources. To enable the disentanglement, on-screen sound separation task may be used as the proxy and a multi-task learning objective may be adopted to train the model where the localization task is solved along with a sound-separation task. To deal with the egomotion in egocentric videos (Q2), a geometry-aware temporal modeling (GATM) approach may be developed to mitigate the feature distortion brought by viewpoint changes and aggregate the visual features temporally. The audio-visual temporal synchronization may be taken as the supervision signal and the localization map Ōᵢ may be estimated.

To extract visual representations, a visual encoder network Eᵥ may extract visual feature maps from each input frame lᵢ. In the disclosed implementation, a pre-trained Dilated ResNet model may be adopted by removing the final fully-connected layer. A group of feature maps vᵢ=Eᵥ(Iᵢ) may be subsequently obtained, where vᵢ∈R^{c×h}^{ᵥ}^{×w}^{ᵥ}. Here c is the number of channels, and hᵥ×wᵥ denotes the spatial size.

To extract audio representations from the input raw waveform, the systems described herein may first transform audio stream s into a magnitude spectrogram X with the short-time Fourier transform (STFT). Then, audio features a=Eₐ(X), a∈R^{c×h}^{ₐ}^{×w}^{ₐ} may be extracted by means of a convolutional neural network (CNN) encoder Eₐ into the Time-Frequency (T-F) space.

As discussed above, a sound source sₙ in the mixture s could be out of view due to constant view changes in egocentric videos and the limited field-of-view (FoV). This poses challenges in visually localizing sound sources and localization performance can degrade when the audio-visual associations are not precise. To address this, the systems described herein may update the features in a cascaded fashion. The network may first be forced to learn disentangled audio representations from the mixture input using visual guidance. Then the disentangled audio representations may be utilized to inject the visual features with more localization cues.

Sound source localization objective can implicitly guide the system to learn disentangled audio features as the network will try to precisely localize the sound, and in turn, the on-screen sound will get disentangled from the rest. However, the problem may be formulated in an unsupervised setting where labels for such localization objective are not available.

An audio-visual sound separation task may use visual information as guidance to learn to separate individual sounds from a mixture. Given the visual guidance, it is expected that the learned representations mainly encode information from visually indicated sound sources. Hence, a multi-task learning approach may be utilized in the disclosed network to solve the primary task. Along with the audio-visual sounding object localization task, the network also learns to disentangle visible audio representations from the mixture through a source separation task.

The systems described herein may adopt a “mix-and-separate” strategy for audio-visual sound separation. Given the current audio s⁽¹⁾, another audio stream s⁽²⁾ may be randomly sampled from a different video and the two audio streams may be mixed together to generate input audio mixture \tilde{s}=s⁽¹⁾+s⁽²⁾. Magnitude spectrograms \tilde{X}, X⁽¹⁾, and X⁽²⁾ may then be obtained for s, s⁽¹⁾, and s⁽²⁾ respectively. The audio features may then be modified as a=Eₐ(\tilde{X}).

During inference, the original audio stream may be taken as input: s=s⁽¹⁾ and X=X⁽¹⁾ to extract visually correlated audio representations. Note that the audio features are a=Eₐ(X).

The audio disentanglement network may be defined as a network f(⋅), which produces the disentangled audio features â∈R^{c×h}^{ₐ}^{×w}^{ₐ}. In this network, the visual content may be associated with the audio representations to perform disentanglement in the embedding space. Concretely, spatial average pooling may first be applied on each vᵢ and temporal max pooling may be applied along the time axis to obtain a visual feature vector gᵥ∈R^{c}. Then the visual feature vector may be replicated hₐ×wₐ times and tiled to match the size of a. The visual and audio feature maps may be concatenated along the channel dimension and fed into the network. Therefore, the audio feature disentanglement can be formulated as:

$$\hat{a} = f ( Concat [ a , Tile ( {g}_{v} ) ] ) . \qquad ( 1 )$$

In practice, the disentanglement network f may be implemented using two 1×1 convolution layers. The audio feature â may be used for both separation mask and sounding object localization map generation.

To separate visible sounds, an audio decoder Dₐ may be added following the disentanglement network to output a binary mask M_{pred}=Dₐ(â) (see the bottom of FIG. 2). U-Net architectures may be used in the audio encoder Eₐ and decoder Dₐ. The Eₐ and Dₐ may be implemented in five down-convolution and up-convolution layers, respectively. The ground truth separation mask M_{gt} can be calculated by determining whether the original input sound is dominant at locations (u, v) in the T-F space:

$${M}_{gt} ( u , v ) = [ {X}^{( 1 )} ( u , v ) \geq \tilde{X} ( u , v ) ] . \qquad ( 2 )$$

To train the sound separator, the l₂ distance between the predicted and ground-truth masks may be minimized as the disentanglement learning objective:

$${ℒ}_{dis} = {‖ {M}_{pred} - {M}_{gt} ‖}_{2}^{2} . \qquad ( 3 )$$

Similar to the out-of-view sounds, the visual frames may contain sound-irrelevant regions. In order to learn more precise audio-visual associations, the spatial regions that are more likely to be correlated with the on-screen sounds may be highlighted by computing audio-visual attention. The attention map will indicate the correlation between audio and visual representations at different spatial locations. Given the output â from disentanglement network f(⋅), max pooling on its time and frequency dimensions may be applied, obtaining an audio feature vector g_{â}. Then at each spatial position (x,y) of visual feature vᵢ, the cosine similarity between audio and visual feature vectors may be computed:

Sᵢ:Sᵢ(x,y)=COSINESIM(vᵢ(x,y),g_{â}). (4)

SOFTMAX may then then used on Sᵢ to generate a soft mask that represents the audio-visual correspondence. Hence, each vᵢ can be attended with the calculated weights:

\hat{v}ᵢ=SOFTMAX(Sᵢ)·vᵢ. (5)

Since sounds are naturally temporal phenomena and the audio-visual associations are expected to persist for some duration, temporal information may be incorporated from neighboring frames to learn sounding object features. However, temporal modeling is a challenging problem for egocentric videos due to widespread egomotion and object-appearance deformations.

Although visual objects are dynamically changing, the surrounding physical environment is persistent. Hence, temporal variations in egocentric videos reveal rich 3D geometric cues that can recover the surrounding scene from changing viewpoints. Prior works have shown that given a sequence of frames, one can reconstruct the underlying 3D scene from the 2D observations. In the present disclosure, rather than reconstructing the 3D structures, the relative geometric transformation has been estimated between frames to alleviate egomotion. Specifically, the transformation at the feature level has been applied to perform geometry-aware temporal aggregation. Given {Iᵢ}ᵢ₌₁^{T} and their features {\hat{v}ᵢ}ᵢ₌₁^{T}, \hat{v}ᵢ may be taken as a query at a time and the other features from neighboring frames may be used as support features to aggregate temporal contexts. For clarity, the geometry-aware temporal aggregation may be decomposed into two parts, namely geometry modeling and temporal aggregation.

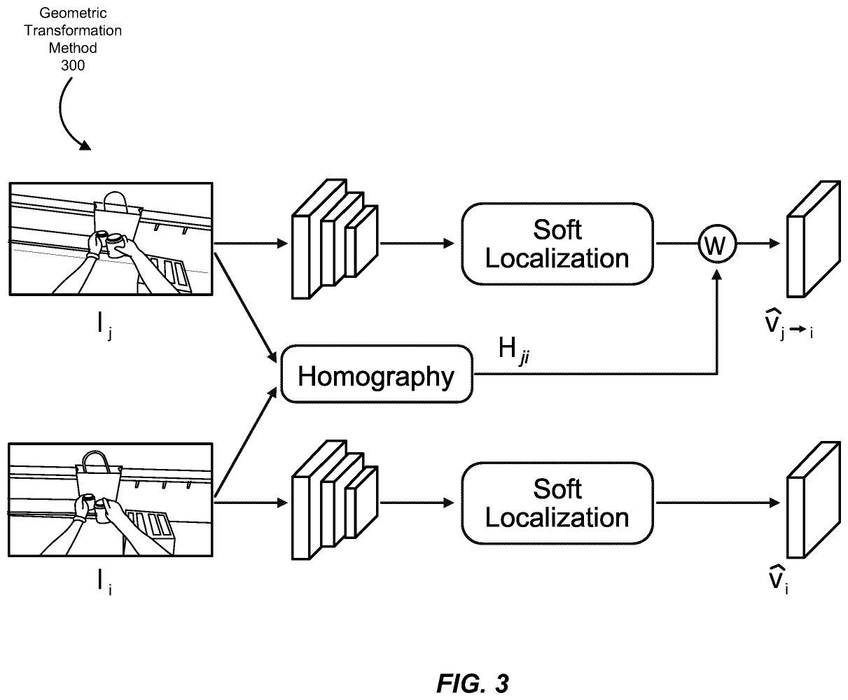

The geometry modeling step aims to compute the geometric transformation that represents the egomotion between frames, as illustrated in FIG. 3. It has been found that homography estimation, which can align images taken from different perspectives, can serve as a way to measure geometric transformation. SIFT+RANSAC may be adopted to solve homography. To be specific, a homography is a 3×3 matrix that includes 8 degrees of freedom (DOF) for scale, translation, rotation, and perspective respectively. As illustrated in geometric transformation method 300, given the query frame Iᵢ and a supporting frame Iⱼ, h(⋅) may be used to denote the computation process:

[symbol]

=h(Iⱼ,Iᵢ)_{j→i}, (6)

where [symbol] represents the homography transformation from frame Iⱼ to Iᵢ. With the computed homography transformation, it can then be applied at the feature level to transform visual features [symbol] to [symbol] . The [symbol] is egomotion-free under the viewpoint of Iᵢ. Since the resolution of feature maps may be scaled down compared to the raw frame size, the homography matrix [symbol] should also be downsampled using the same scaling factor. The feature transformation can be written as:

[symbol]

= [symbol] ⊗ [symbol] , (7)

where ⊗ represents the warping operation.

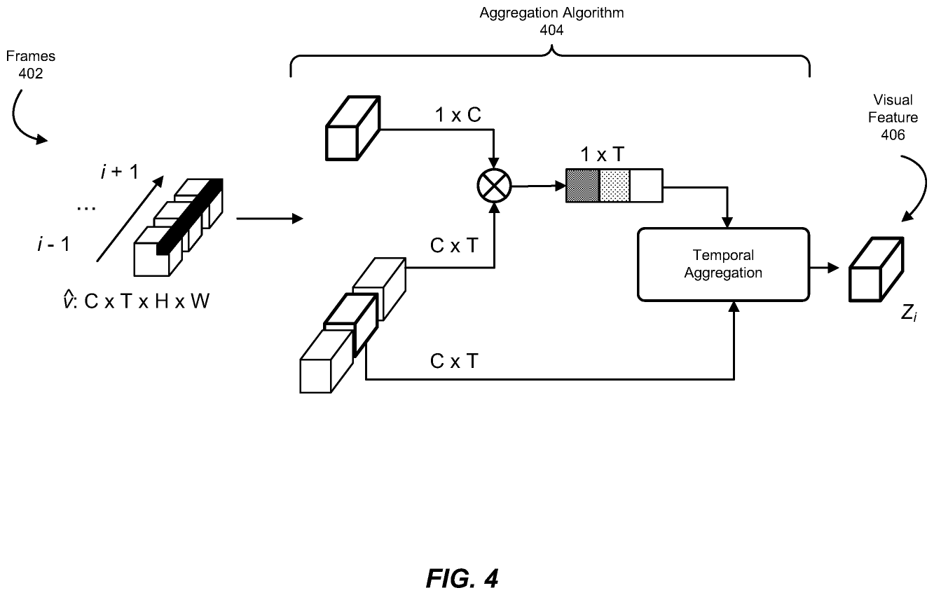

For the query feature [symbol] , a set of aligned features { [symbol] }ⱼ₌₁^{T} corresponding to the same viewpoint may be generated. To aggregate the temporal contexts, the correlation between features from different frames may be computed at the same locations, as illustrated in FIG. 4, where an aggregation algorithm 404 receives frames 402 as input and performs temporal aggregation to produce visual feature 406. The aggregation process can be formulated as:

$${z}_{i} ( x , y ) = {\hat{v}}_{ι} ( x , y ) + SOFTMAX ( \frac{{\hat{v}}_{ι} ( x , y ) {\hat{v} ( x , y )}^{T}}{\sqrt{d}} ) \hat{v} ( x , y ) , \qquad ( 8 )$$

where \hat{v}=[ [symbol] ; . . . ; [symbol] ] is the concatenation of frame features; the scaling factor d is equal to the feature dimension; and (⋅)^{T} represents the transpose operation. The aggregation operation is applied at all spatial locations (x,y) to generate the updated visual features zᵢ.

Audio-visual synchronization may be taken as the “free” supervision and the sounding object localization task may be solved in a self-supervised manner using contrastive learning.

With the audio feature vector g_{â} and the visual features {zᵢ}₁, an audio-visual attention map Sᵢ may be computed in Eq. 4 for each frame Iᵢ. The training objective may optimize the network such that only the sounding regions have a high response in Sᵢ. Since the ground-truth sounding map is unknown, differential thresholding may be applied on Sᵢ to predict sounding objectness map Oᵢ=sigmoid((Sᵢ−∈)/τ), where ∈ is the threshold, and τ denotes the temperature that controls the sharpness.

In an egocentric video clip, a visual scene may be temporally dynamic. Sometimes a single audio-visual pair (Iᵢ,s) may not be audio-visually correlated. To this end, the localization task may be solved in a Multiple-Instance Learning (MIL) setting to improve robustness. Concretely, a soft MIL pooling function may be used to aggregate the concatenated attention maps S=[S₁; . . . ; S_{T}] by assigning different weights to Sₜ at different time steps:

$$\overline{S} = {\sum }_{t = 1}^{T} ( {W}_{t} \cdot S ) [ : , : , t ] , \qquad ( 9 )$$

where Wₜ[x,y,:]=SOFTMAX(S[x,y,:]), x and y are the indices on spatial dimensions. Subsequently, an aggregated sounding objectness map Ō may be calculated from S̅. In this way, for each video clip V in the batch, its positive and negative training signals may be defined as:

$$P = \frac{1}{\vert \overline{O} \vert} 〈 \overline{O} , \overline{S} 〉 , N = \frac{1}{hw} 〈 1 , {S}_{neg} 〉 , \qquad ( 10 )$$

where [symbol] ⋅,⋅ [symbol] is the Frobenius inner product.

Negative audio-visual attention maps S_{neg} may be obtained by associating the current visual inputs/with audio from other video clips. “1” in Eq. 10 denotes an all-ones tensor with shape h×w. Therefore, the localization optimization objective is:

$${ℒ}_{ℓℴ𝒸} = - \frac{1}{N} {\sum }_{k = 1}^{N} [ log \frac{exp ( {P}_{k} )}{exp ( {P}_{k} ) + exp ( {N}_{k} )} ] , \qquad ( 11 )$$

where k is the video sample index in a training batch. The overall objective is [symbol] = [symbol] +λ [symbol] , where λ=5 is empirically set in the experiments.

The systems described herein may use a variety of source visual localization evaluation datasets, including the Epic Sounding Object Dataset utilized for egocentric audio-visual sounding object localization. Existing sound source visual localization evaluation datasets may only contain third-person recordings. Thus, the systems described herein created an Epic Sounding Object Dataset for egocentric audio-visual sounding object localization. The systems described herein collected sounding object annotations on its action recognition test set. A set of test videos from an existing data set were selected and pruned for suitability. Since these videos are not originally collected for audiovisual analysis, they vary in length, and not all of them contain meaningful sounds. To verify the videos for annotations, a two-step process was conducted. First, silent videos were filtered out to provide a meaningful data source. Second, the center 1-second clip was trimmed from each video. For each video, the systems described herein uniformly selected three frames and annotated sounding objects in the frames. To obtain proposals of potential sounding objects automatically, the systems described herein used a Mask RCNN object detector trained on MS-COCO and a hand-objects detector that pretrained with 42K egocentric images.

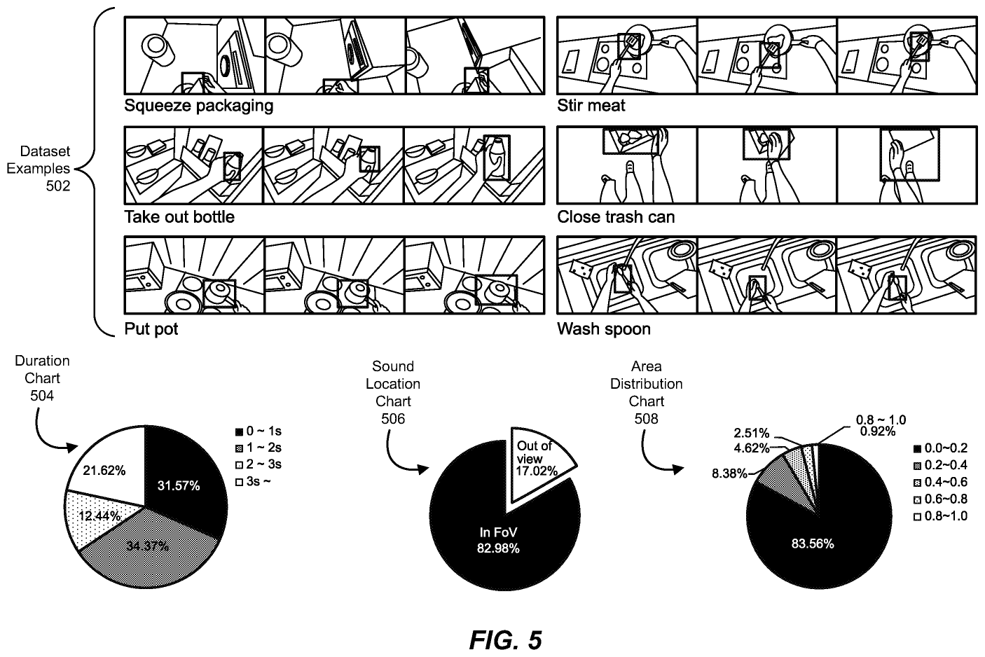

Given the pre-processed data, the sounding objects were annotated manually. After annotation, the systems described herein obtained thirty classes of sounds such as “open fridge,” “cut food,” and “move pan/pot.” The annotations are evenly split into two sets for validation and testing. FIG. 5 illustrates Epic Sounding Object dataset examples in accordance with some embodiments. As illustrated in FIG. 5, dataset examples 502 may include examples of video frames and sounding object annotations, with class diversity that includes different sounds such as squeezing packaging, stirring meat, closing a trash can, putting down a pot, and/or washing a spoon. In this example, duration chart 504 illustrates the distribution of untrimmed video duration in dataset examples 502, sound location chart 506 illustrates the number of videos that are annotated as containing out-of-view sounds in dataset examples 502, and area distribution chart 508 illustrates the distribution of bounding box areas dataset examples 502, with the majority of boxes covering less than 20% of the image area, demonstrating the difficulty of this task.

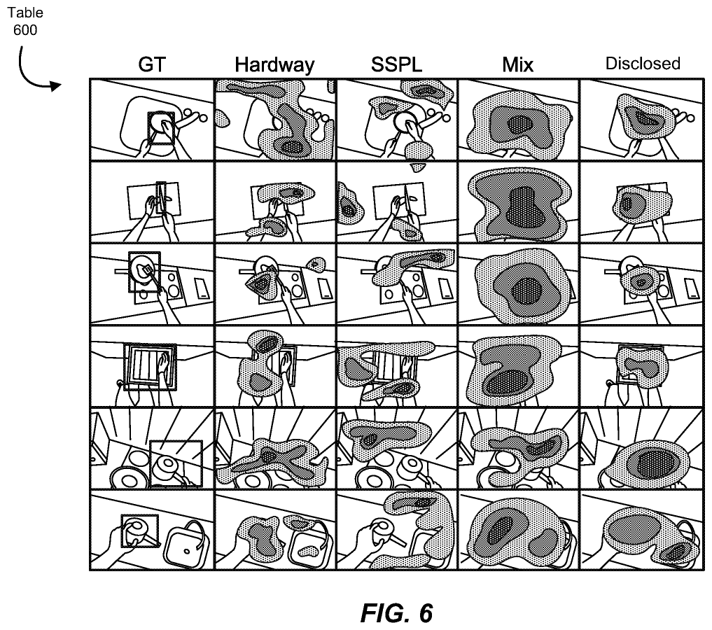

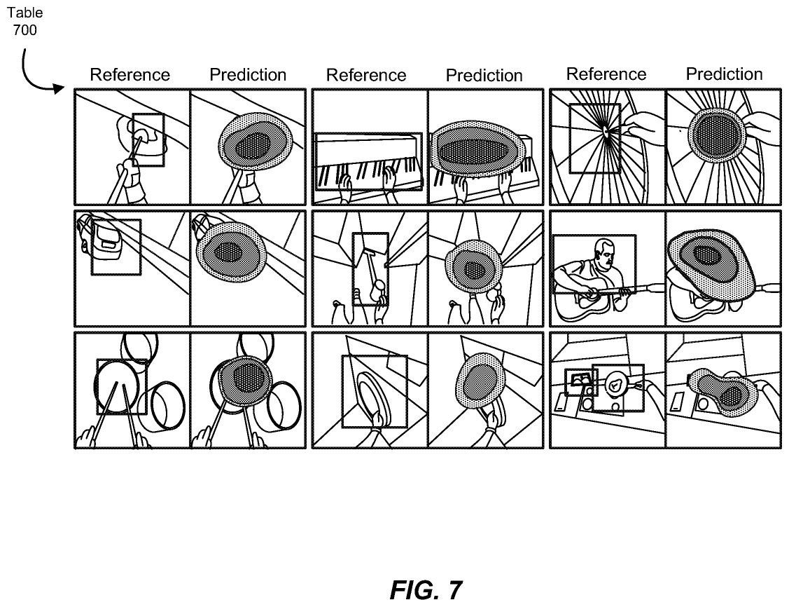

Table 600 in FIG. 6 shows qualitative comparisons of the disclosed method on the Epic Sounding Object Dataset versus other methods for object localization. As illustrated in FIG. 6, the disclosed method is more accurate at localization in each example frame than the comparison methods. Table 700 in FIG. 7 illustrates localization results on diverse scenarios in Ego4D dataset.

In this work, a fundamental task is tackled: egocentric audio-visual localization to promote the field of study in egocentric audio-visual video understanding. The uniqueness of egocentric videos such as egomotions and out-of-view sounds pose significant challenges to learning fine-grained audio-visual associations. To address these problems, a new framework with a cascaded feature enhancement module may be used to disentangle visually indicated audio representations and a geometry-aware temporal modeling module to mitigate egomotion. Extensive experiments on the annotated Epic Sounding Object dataset underpin the findings that explicitly mitigating out-of-view sounds and egomotion can boost localization performance and learn the better audio-visual association for egocentric videos.

The proposed geometry-aware temporal modeling approach requires geometric transformation computation. For certain visual scenes with severe illumination changes or drastic motions, the homography estimation may fail. Then, the disclosed model will degrade to a plane temporal modeling approach. To mitigate the issue, a more robust geometric estimation approach may be designed.

The system and method disclosed herein have the potential to facilitate a range of applications. For example, as egocentric video records the “what” and “where” of an individual's daily life experiences, it may be desirable to build an intelligent AR assistant to localize an object (“where did I use it?”) by processing an audio query, e.g., an audio clip of a “vacuum cleaner.” Additionally, in egocentric research, it may be important to know the state of objects that a human is interacting with, particularly when the human-object interaction makes a sound. Therefore, localizing objects by sounds may provide a new angle in recognizing an object state. In some examples, following the audio-visual object state recognition task, it is natural to predict the trajectory of a sounding object by analyzing the most recent audio-visual clips.

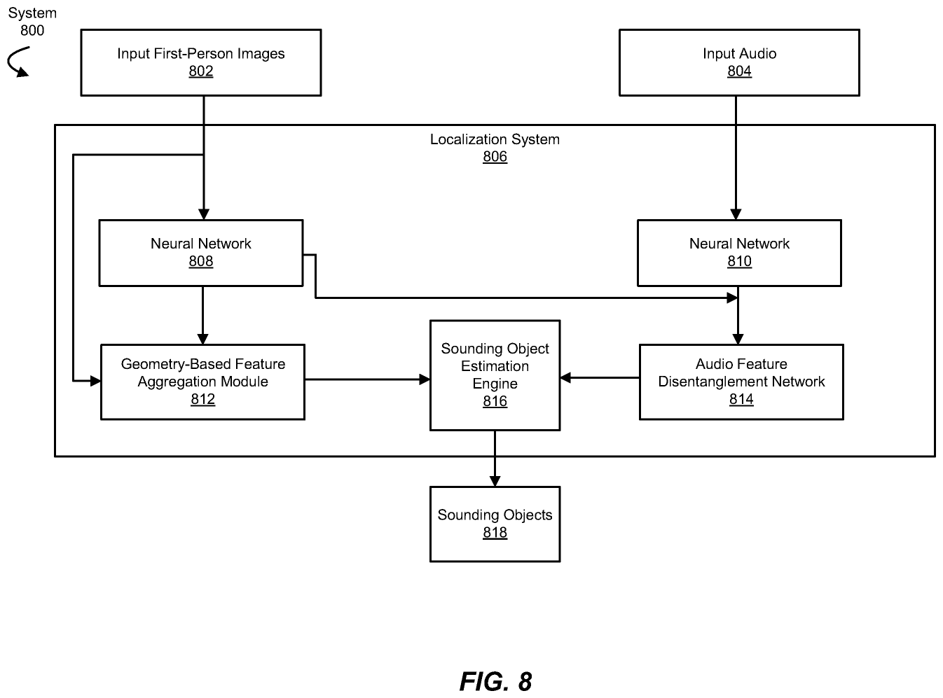

FIG. 8 shows a block diagram of a system 800 for localizing objects that emit sounds in the images in egocentric videos. In one example, a localization system 806 may receive input first-person images 802 and input audio 804 and feed this input to neural networks 808 and 810, respectively. In one embodiment, neural network 808 may send output to a geometry-based feature aggregation module 812 and/or to an audio feature disentanglement network 814 that also receives data from neural network 810. In this embodiment, geometry-based feature aggregation module 812 and audio feature disentanglement network 814 may send data to a sounding object estimation engine 816 that produces sounding objects 818. The method performed by system 800 may include receiving synchronized images and audio data from egocentric (first-person) videos and processing this two-stream data to generate the location of sounding objects in the images. Existing approaches may estimate the location of the sounding objects in third-person view videos but ignore unique characteristics of egocentric videos. In contrast, the disclosed system may handle the egomotion and out-of-view sounds in first-person recordings and produce more precise locations for sounding objects.

According to some embodiments, the system may take images and audio from first-person recordings as inputs and generate a heatmap representing the location of sounding objects in the first-person view images. The system may include a geometry-based feature aggregation module, which mitigates the egomotion in egocentric videos by first estimating the geometric transformation between images, and later applying it to the visual features for effective aggregation. The system may also include an audio feature disentanglement network that receives an audio mixture and visual features, and outputs visually correlated audio features.

The disclosed system may have the merit of serving many applications, including augmented/virtual reality (AR/VR), robotics, and health care, in addition to many other applications. For instance, in AR environments, the systems described herein may play the audio elements and/or display the visual elements so that a user may view the integration of artificial graphics with the user's natural surroundings. This system can provide graphical guidance about which object is emitting sound in the user's field of view and enhance his/her experience of interaction in the AR environment. Moreover, this system can help robot navigation and predict human health conditions, etc.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

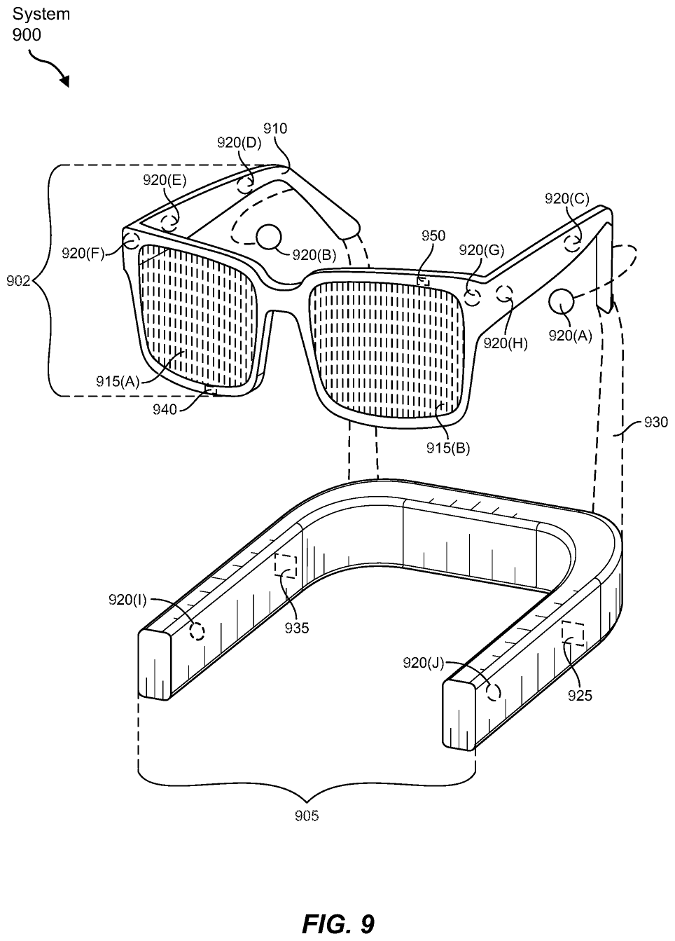

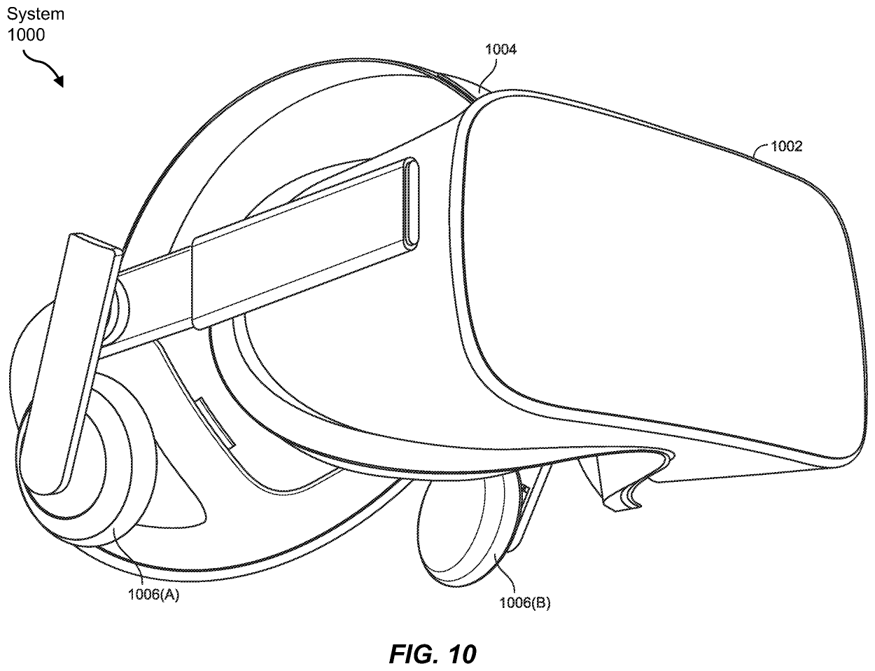

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 900 in FIG. 9) or that visually immerses a user in an artificial reality (such as, e.g., virtual-reality system 1000 in FIG. 10). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 9, augmented-reality system 900 may include an eyewear device 902 with a frame 910 configured to hold a left display device 915(A) and a right display device 915(B) in front of a user's eyes. Display devices 915(A) and 915(B) may act together or independently to present an image or series of images to a user. While augmented-reality system 900 includes two displays, embodiments of this disclosure may be implemented in augmented-reality systems with a single NED or more than two NEDs.

In some embodiments, augmented-reality system 900 may include one or more sensors, such as sensor 940. Sensor 940 may generate measurement signals in response to motion of augmented-reality system 900 and may be located on substantially any portion of frame 910. Sensor 940 may represent one or more of a variety of different sensing mechanisms, such as a position sensor, an inertial measurement unit (IMU), a depth camera assembly, a structured light emitter and/or detector, or any combination thereof. In some embodiments, augmented-reality system 900 may or may not include sensor 940 or may include more than one sensor. In embodiments in which sensor 940 includes an IMU, the IMU may generate calibration data based on measurement signals from sensor 940. Examples of sensor 940 may include, without limitation, accelerometers, gyroscopes, magnetometers, other suitable types of sensors that detect motion, sensors used for error correction of the IMU, or some combination thereof.

In some examples, augmented-reality system 900 may also include a microphone array with a plurality of acoustic transducers 920(A)-920(J), referred to collectively as acoustic transducers 920. Acoustic transducers 920 may represent transducers that detect air pressure variations induced by sound waves. Each acoustic transducer 920 may be configured to detect sound and convert the detected sound into an electronic format (e.g., an analog or digital format). The microphone array in FIG. 9 may include, for example, ten acoustic transducers: 920(A) and 920(B), which may be designed to be placed inside a corresponding ear of the user, acoustic transducers 920(C), 920(D), 920(E), 920(F), 920(G), and 920(H), which may be positioned at various locations on frame 910, and/or acoustic transducers 920(I) and 920(J), which may be positioned on a corresponding neckband 905.

In some embodiments, one or more of acoustic transducers 920(A)-(J) may be used as output transducers (e.g., speakers). For example, acoustic transducers 920(A) and/or 920(B) may be earbuds or any other suitable type of headphone or speaker.

The configuration of acoustic transducers 920 of the microphone array may vary. While augmented-reality system 900 is shown in FIG. 9 as having ten acoustic transducers 920, the number of acoustic transducers 920 may be greater or less than ten. In some embodiments, using higher numbers of acoustic transducers 920 may increase the amount of audio information collected and/or the sensitivity and accuracy of the audio information. In contrast, using a lower number of acoustic transducers 920 may decrease the computing power required by an associated controller 950 to process the collected audio information. In addition, the position of each acoustic transducer 920 of the microphone array may vary. For example, the position of an acoustic transducer 920 may include a defined position on the user, a defined coordinate on frame 910, an orientation associated with each acoustic transducer 920, or some combination thereof.

Acoustic transducers 920(A) and 920(B) may be positioned on different parts of the user's ear, such as behind the pinna, behind the tragus, and/or within the auricle or fossa. Or, there may be additional acoustic transducers 920 on or surrounding the ear in addition to acoustic transducers 920 inside the ear canal. Having an acoustic transducer 920 positioned next to an ear canal of a user may enable the microphone array to collect information on how sounds arrive at the ear canal. By positioning at least two of acoustic transducers 920 on either side of a user's head (e.g., as binaural microphones), augmented-reality device 900 may simulate binaural hearing and capture a 3D stereo sound field around about a user's head. In some embodiments, acoustic transducers 920(A) and 920(B) may be connected to augmented-reality system 900 via a wired connection 930, and in other embodiments acoustic transducers 920(A) and 920(B) may be connected to augmented-reality system 900 via a wireless connection (e.g., a BLUETOOTH connection). In still other embodiments, acoustic transducers 920(A) and 920(B) may not be used at all in conjunction with augmented-reality system 900.

Acoustic transducers 920 on frame 910 may be positioned in a variety of different ways, including along the length of the temples, across the bridge, above or below display devices 915(A) and 915(B), or some combination thereof. Acoustic transducers 920 may also be oriented such that the microphone array is able to detect sounds in a wide range of directions surrounding the user wearing the augmented-reality system 900. In some embodiments, an optimization process may be performed during manufacturing of augmented-reality system 900 to determine relative positioning of each acoustic transducer 920 in the microphone array.

In some examples, augmented-reality system 900 may include or be connected to an external device (e.g., a paired device), such as neckband 905. Neckband 905 generally represents any type or form of paired device. Thus, the following discussion of neckband 905 may also apply to various other paired devices, such as charging cases, smart watches, smart phones, wrist bands, other wearable devices, hand-held controllers, tablet computers, laptop computers, other external compute devices, etc.

As shown, neckband 905 may be coupled to eyewear device 902 via one or more connectors. The connectors may be wired or wireless and may include electrical and/or non-electrical (e.g., structural) components. In some cases, eyewear device 902 and neckband 905 may operate independently without any wired or wireless connection between them. While FIG. 9 illustrates the components of eyewear device 902 and neckband 905 in example locations on eyewear device 902 and neckband 905, the components may be located elsewhere and/or distributed differently on eyewear device 902 and/or neckband 905. In some embodiments, the components of eyewear device 902 and neckband 905 may be located on one or more additional peripheral devices paired with eyewear device 902, neckband 905, or some combination thereof.

Pairing external devices, such as neckband 905, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 900 may be provided by a paired device or shared between a paired device and an eyewear device, thus reducing the weight, heat profile, and form factor of the eyewear device overall while still retaining desired functionality. For example, neckband 905 may allow components that would otherwise be included on an eyewear device to be included in neckband 905 since users may tolerate a heavier weight load on their shoulders than they would tolerate on their heads. Neckband 905 may also have a larger surface area over which to diffuse and disperse heat to the ambient environment. Thus, neckband 905 may allow for greater battery and computation capacity than might otherwise have been possible on a stand-alone eyewear device. Since weight carried in neckband 905 may be less invasive to a user than weight carried in eyewear device 902, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 905 may be communicatively coupled with eyewear device 902 and/or to other devices. These other devices may provide certain functions (e.g., tracking, localizing, depth mapping, processing, storage, etc.) to augmented-reality system 900. In the embodiment of FIG. 9, neckband 905 may include two acoustic transducers (e.g., 920(I) and 920(J)) that are part of the microphone array (or potentially form their own microphone subarray). Neckband 905 may also include a controller 925 and a power source 935.

Acoustic transducers 920(I) and 920(J) of neckband 905 may be configured to detect sound and convert the detected sound into an electronic format (analog or digital). In the embodiment of FIG. 9, acoustic transducers 920(I) and 920(J) may be positioned on neckband 905, thereby increasing the distance between the neckband acoustic transducers 920(I) and 920(J) and other acoustic transducers 920 positioned on eyewear device 902. In some cases, increasing the distance between acoustic transducers 920 of the microphone array may improve the accuracy of beamforming performed via the microphone array. For example, if a sound is detected by acoustic transducers 920(C) and 920(D) and the distance between acoustic transducers 920(C) and 920(D) is greater than, e.g., the distance between acoustic transducers 920(D) and 920(E), the determined source location of the detected sound may be more accurate than if the sound had been detected by acoustic transducers 920(D) and 920(E).

Controller 925 of neckband 905 may process information generated by the sensors on neckband 905 and/or augmented-reality system 900. For example, controller 925 may process information from the microphone array that describes sounds detected by the microphone array. For each detected sound, controller 925 may perform a direction-of-arrival (DOA) estimation to estimate a direction from which the detected sound arrived at the microphone array. As the microphone array detects sounds, controller 925 may populate an audio data set with the information. In embodiments in which augmented-reality system 900 includes an inertial measurement unit, controller 925 may compute all inertial and spatial calculations from the IMU located on eyewear device 902. A connector may convey information between augmented-reality system 900 and neckband 905 and between augmented-reality system 900 and controller 925. The information may be in the form of optical data, electrical data, wireless data, or any other transmittable data form. Moving the processing of information generated by augmented-reality system 900 to neckband 905 may reduce weight and heat in eyewear device 902, making it more comfortable to the user.

Power source 935 in neckband 905 may provide power to eyewear device 902 and/or to neckband 905. Power source 935 may include, without limitation, lithium ion batteries, lithium-polymer batteries, primary lithium batteries, alkaline batteries, or any other form of power storage. In some cases, power source 935 may be a wired power source. Including power source 935 on neckband 905 instead of on eyewear device 902 may help better distribute the weight and heat generated by power source 935.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1000 in FIG. 10, that mostly or completely covers a user's field of view. Virtual-reality system 1000 may include a front rigid body 1002 and a band 1004 shaped to fit around a user's head. Virtual-reality system 1000 may also include output audio transducers 1006(A) and 1006(B). Furthermore, while not shown in FIG. 10, front rigid body 1002 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 900 and/or virtual-reality system 1000 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 900 and/or virtual-reality system 1000 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 900 and/or virtual-reality system 1000 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

### EXAMPLE EMBODIMENTS

Example 1: A localization system may include an image input that receives images from a video source, an audio input that receives, from the video source, audio synchronized with the images, and an audio feature disentanglement network that correlates distinct audio elements from the audio input with corresponding visual features from the image input.

Example 2: The localization system of example 1, where the images received from the video source include first-person videos.

Example 3: The localization system of examples 1-2 may further include a geometry-based feature aggregation module that estimates a geometric transformation between two or more images from the video source and aggregates visual features based on that geometric transformation.

Example 4: The localization system of examples 1-3 may further include a sounding object estimation engine that correlates the distinct audio elements with object locations of the visual features from the image input.

Example 5: The localization system of examples 1-4, where the visual features are determined based on the geometric transformation.

Example 6: The localization system of examples 1-5, where the audio feature disentanglement network includes at least one convolution layer.

Example 7: The localization system of examples 1-6 may further include an augmented reality module that plays the distinct audio elements from the audio input in conjunction with displaying the corresponding visual features in an augmented reality environment.

Example 8: A method for audio localization may include receiving, at an image input, images from a video source, receiving, at an audio input, audio from the video source, the audio being synchronized with the images, and correlating, at an audio feature disentanglement network, distinct audio elements from the audio input with corresponding visual features from the image input.

Example 9: The method of example 8, where the images received from the video source include first-person videos.

Example 10: The method of examples 8-9 may further include estimating a geometric transformation between two or more images from the video source and aggregating visual features based on that geometric transformation.

Example 11: The method of examples 8-10 may further include correlating the distinct audio elements with object locations of the visual features from the image input.

Example 12: The method of examples 8-11, where visual features are determined based on the geometric transformation.

Example 13: The method of examples 8-12, where the audio feature disentanglement network includes at least one convolution layer.

Example 14: The method of examples 8-13 may further include playing the distinct audio elements from the audio input while displaying the corresponding visual features in an augmented reality environment.

Example 15: A non-transitory computer-readable medium may include one or more computer-readable instructions that, when executed by at least one processor of a computing device, cause the computing device to receive, at an image input, images from a video source, receive, at an audio input, audio from the video source, the audio being synchronized with the images, and correlate, at an audio feature disentanglement network, distinct audio elements from the audio input with corresponding visual features from the image input.

Example 16: The non-transitory computer-readable medium of examples 14-15, where the images received from the video source include first-person videos.

Example 17: The non-transitory computer-readable medium of examples 14-16, where the computer-readable instructions cause the computing device to estimate a geometric transformation between two or more images from the video source and aggregate visual features based on that geometric transformation.

Example 18: The non-transitory computer-readable medium of examples 14-17, where the computer-executable instructions cause the computing device to correlate the distinct audio elements with object locations of the visual features from the image input.

Example 19: The non-transitory computer-readable medium of examples 14-18, where the visual features are determined based on the geometric transformation.

Example 20: The non-transitory computer-readable medium of examples 14-19, where the audio feature disentanglement network includes at least one convolution layer.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A localization system, comprising:
an image input that receives images from a video source;
an audio input that receives, from the video source, audio synchronized with the images; and
an audio feature disentanglement network that correlates distinct audio elements from the audio input with corresponding visual features from the image input.

2. The localization system of claim 1, wherein the images received from the video source comprise first-person videos.

3. The localization system of claim 1, further comprising a geometry-based feature aggregation module that estimates a geometric transformation between two or more images from the video source and aggregates visual features based on that geometric transformation.

4. The localization system of claim 3, further comprising a sounding object estimation engine that correlates the distinct audio elements with object locations of the visual features from the image input.

5. The localization system of claim 4, wherein the visual features are determined based on the geometric transformation.

6. The localization system of claim 1, wherein the audio feature disentanglement network comprises at least one convolution layer.

7. The localization system of claim 1, further comprising an augmented reality module that plays the distinct audio elements from the audio input in conjunction with displaying the corresponding visual features in an augmented reality environment.

8. A method, comprising:
receiving, at an image input, images from a video source;
receiving, at an audio input, audio from the video source, the audio being synchronized with the images; and
correlating, at an audio feature disentanglement network, distinct audio elements from the audio input with corresponding visual features from the image input.

9. The method of claim 8, wherein the images received from the video source comprise first-person videos.

10. The method of claim 8, further comprising estimating a geometric transformation between two or more images from the video source and aggregating visual features based on that geometric transformation.

11. The method of claim 10, further comprising correlating the distinct audio elements with object locations of the visual features from the image input.

12. The method of claim 10, wherein the visual features are determined based on the geometric transformation.

13. The method of claim 8, wherein the audio feature disentanglement network comprises at least one convolution layer.

14. The method of claim 8, further comprising playing the distinct audio elements from the audio input while displaying the corresponding visual features in an augmented reality environment.

15. A non-transitory computer-readable medium comprising one or more computer-readable instructions that, when executed by at least one processor of a computing device, cause the computing device to:
receive, at an image input, images from a video source;
receive, at an audio input, audio from the video source, the audio being synchronized with the images; and
correlate, at an audio feature disentanglement network, distinct audio elements from the audio input with corresponding visual features from the image input.

16. The non-transitory computer-readable medium of claim 15, wherein the images received from the video source comprise first-person videos.

17. The non-transitory computer-readable medium of claim 15, wherein the computer-readable instructions cause the computing device to estimate a geometric transformation between two or more images from the video source and aggregate visual features based on that geometric transformation.

18. The non-transitory computer-readable medium of claim 17, wherein the computer-readable instructions cause the computing device to correlate the distinct audio elements with object locations of the visual features from the image input.

19. The non-transitory computer-readable medium of claim 17, wherein the visual features are determined based on the geometric transformation.

20. The non-transitory computer-readable medium of claim 15, wherein the audio feature disentanglement network comprises at least one convolution layer.
